(19) United States
(12) Patent Application Publication
(10) Pub. No.: US 2024/0106278 A1
(43) Pub. Date: Mar. 28, 2024

(54) CHARGING SYSTEMS FOR PORTABLE ELECTRONIC DEVICES WITHIN ENCLOSED ENVIRONMENTS

(71) Applicant: Apple Inc., Cupertino, CA (US)

(72) Inventors: Xiaofei SUN, Beijing (CN); Qiaojian SONG, Singapore (SG); Xinjian ZHANG, Beijing (CN); Yan GAO, Beijing (CN)

(21) Appl. No.: 18/236,911

(22) Filed: Aug. 22, 2023

(30) Foreign Application Priority Data
Sep. 23, 2022 (CN) 202211162913.4

(51) Int. Cl. H02J 50/20; H02J 50/40; H04B 1/7163

(52) U.S. Cl. CPC H02J 50/20; H02J 50/40; H04B 1/71635; H04B 2201/71634

(57) ABSTRACT

Implementations of the subject technology described herein provide for spatial modeling of enclosed environments for guiding charging beams wirelessly to portable electronic devices within the enclosed environment. For example, a mapping sensor, such as an ultra-wideband (UWB) sensor may be used to generate a spatial model of the enclosed space and/or to determine the location of one or more occupants within the enclosed space. The charging beams can be guided based on the spatial model to avoid objects and/or occupants within the enclosed space that would otherwise block the wireless charging beam.

### CROSS-REFERENCE TO RELATED APPLICATION

This application claims the benefit of Chinese Patent Application No. 202211162913.4, entitled “CHARGING SYSTEMS FOR PORTABLE ELECTRONIC DEVICES WITHIN ENCLOSED ENVIRONMENTS,” filed Sep. 23, 2022, the entirety of which is incorporated herein by reference.

### TECHNICAL FIELD

The present description relates generally to charging electronic devices, including, for example, charging systems for charging portable electronic device within an enclosed environment.

### BACKGROUND

Portable electronic devices can be powered based on a power source that can be recharged to sustain operations of the portable electronic devices. Portable electronic devices are often deployed in enclosed spaces, such as vehicles and conference rooms, to perform functions for the population of occupants in the enclosed space.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example apparatus in accordance with one or more implementations.

FIG. 2 illustrates a block diagram of the example apparatus of FIG. 1 in accordance with one or more implementations.

FIG. 3 illustrates a top view of an example apparatus in accordance with one or more implementations.

FIG. 4 illustrates a top view of the example apparatus of FIG. 3 in accordance with one or more implementations.

FIG. 5 illustrates a block diagram of a charging system and a portable electronic device in accordance with implementations of the subject technology.

FIG. 6 illustrates a flow chart of example operations that may be performed by a charging system for charging a portable electronic device in accordance with implementations of the subject technology.

FIG. 7 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Portable electronic devices can be powered based on a power source that can be recharged to sustain operations of the portable electronic devices. Portable electronic devices are often deployed in enclosed spaces, such as vehicles and conference rooms, to perform functions for the population of occupants in the enclosed space.

Wireless charging techniques, such as RF beam wireless charging, is limited by existing solutions. In some technologies, a transmitter is needed on a client device that is receiving wireless power, so that the client device can transmit a pilot signal for ray path identification. In this approach, the same frequency is used for the pilot signal and the charging beam to facilitate ray path prediction based on the wave propagation environment. Accordingly, the client device needs to periodically cease charging for ray path identification whenever the environment is changed. This can lead to longer charging times. The additional hardware (i.e., RF beam transmitter) on the client device can significantly increase the volume and cost of the client device.

Implementations of the subject technology described herein provide for spatial modeling of enclosed environments for guiding charging beams wirelessly to portable electronic devices within the enclosed environment. In one or more implementations, a moveable platform, such as a vehicle, having an enclosure that defines an enclosed space may also include one or more mapping sensors, such as ultra-wideband (UWB) sensors. The mapping sensors may be used to generate a spatial model of the enclosed space and/or to determine the location of one or more occupants within the enclosed space. In one or more implementations, the charging beams can be guided based on the spatial model to avoid objects and/or occupants within the enclosed space that would otherwise block the wireless charging beam.

UWB sensors can provide accurate positions of the portable electronic devices inside an enclosed space at the centimeter level. UWB sensors can also identify occupants, portable electronic devices, and/or and objects to determine a preferred beam path that minimizes the transmission of energy outside of the target destination. The location detection can be decoupled from the wireless charging. For example, the signals used for detection can be different (e.g., different frequency) than those used for charging. Accordingly, location detection can be performed without interrupting charging. Additionally, multiple devices can be charged simultaneously. Wireless charging can be performed at high efficiency when within relatively short range (e.g., within 1 meter).

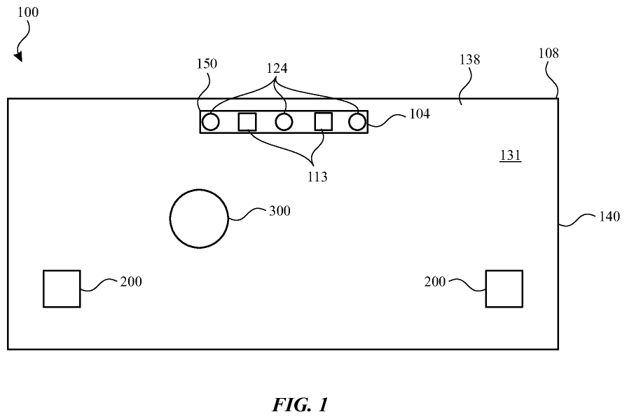

These and other embodiments are discussed below with reference to FIGS. 1-7. However, those skilled in the art will readily appreciate that the detailed description given herein with respect to these Figures is for explanatory purposes only and should not be construed as limiting.

An illustrative apparatus, including a charging system for portable electronic devices within the apparatus, is shown in FIG. 1. In the example of FIG. 1, an apparatus 100 includes an enclosure 108 and a support structure 104. The enclosure may (e.g., at least partially) define an enclosed space 131. In the example of FIG. 1, the enclosure 108 includes top housing structures 138 mounted to and extending across and/or beyond opposing sides of the support structure 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the support structure 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the support structure 104 may be formed from a curved glass structure. In this and/or other implementations, the sidewall housing structure 140 and/or other portions of the enclosure 108 may be or include a reflective surface (e.g., surface that reflect electromagnetic radiation).

As illustrated in FIG. 1, the apparatus 100 may include various components such as a charging system 150. The charging system 150 may include, for example, one or more cameras, and/or one or more sensors such as one or more mapping sensors (e.g., ultra-wideband (UWB) sensors, LIDAR sensors, depth sensors, time-of-flight sensors, and the like). In some implementations, a UWB sensor 113 and/or other sensors may be used to generate a spatial model of the enclosed space 131, to detect an entry or exit of an occupant and/or portable electronic device 200 from the enclosed space 131, and/or to identify the locations of one or more occupants, portable electronic devices 200, and/or objects 300 within the enclosed space 131, as described further herein. In some implementations, a UWB sensor 113 and/or other sensors may be used to detect a location of one or more portable electronic devices 200 within the enclosed space 131, as described further herein.

In various implementations, the apparatus 100 may be implemented as a stationary apparatus (e.g., a conference room or other room within a building) or a moveable apparatus (e.g., a vehicle such as an autonomous vehicle, a train car, an airplane, a boat, a ship, a helicopter, etc.) that can be temporarily occupied by one or more human occupants and/or one or more portable electronic devices 200. In one or more implementations, (although not shown in FIG. 1), the apparatus 100 may include one or more seats for one or more occupants. In one or more implementations, one or more of the seats may be mounted facing in the same direction as one or more other seats, and/or in a different (e.g., opposite) direction of one or more other seats.

In one or more use cases, it may be desirable to provide charging capabilities to one or more portable electronic devices 200 within the enclosed space 131. The charging system 150 can further include one or more charging beam transmitters 124. Each of the charging beam transmitters 124 can be configured to transmit a charging beam to one or more portable electronic devices 200. As shown in FIG. 1, the charging beam transmitters 124 can be positioned within an upper region of the apparatus 100 and/or within the enclosed space 131. Such a position can help the corresponding charging beams be directed to the portable electronic devices 200 while minimizing obstructions by objects 300 (e.g., including structural features of the apparatus 100 and/or any occupants). However, it will be understood that the charging beam transmitters 124 can be positioned within any region of the apparatus 100 and/or within the enclosed space 131. In some implementations, the charging beam transmitters 124 can each have a different position within the enclosed space 131 to provide different potential paths for directing charging beams to the portable electronic devices 200.

In these and/or other use cases, it may be desirable to be able to obtain a spatial model of the enclosed space 131 before and/or after occupants and/or portable electronic devices 200 enter the enclosed environment, and/or to be able to determine and/or track the locations of one or more occupants and/or one or more portable electronic devices 200 within the enclosed space 131.

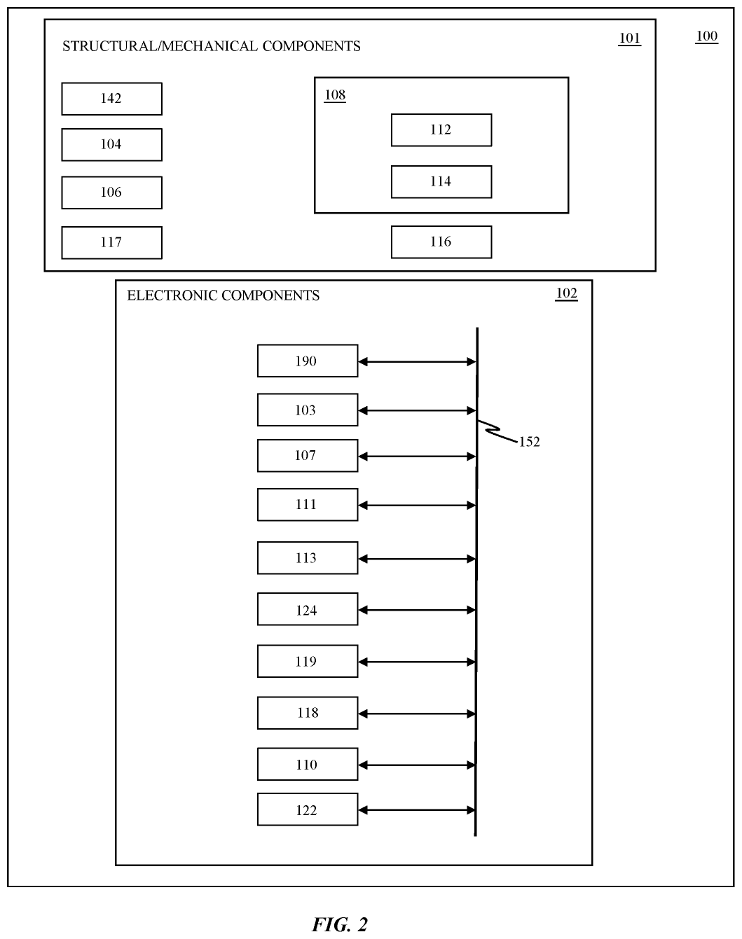

In various implementations, the apparatus 100 may include one or more other structural, mechanical, electronic, and/or computing components and/or circuitry that are not shown in FIG. 1. For example, FIG. 2 illustrates a schematic diagram of the apparatus 100 in accordance with one or more implementations.

As shown in FIG. 2, the apparatus 100 may include structural and/or mechanical components 101 and electronic components 102. In this example, the structural and/or mechanical components 101 include the enclosure 108, the support structure 104, and the safety component 116 of FIG. 1. In this example, the structural and/or mechanical components 101 also include a platform 142, propulsion components 106, and support features 117. In this example, the enclosure 108 includes a reflective surface 112 and an access feature 114.

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed space 131 of FIG. 1, such as one or more seats, benches, and/or one or more other features for supporting and/or interfacing with one or more occupants. As examples, the reflective surface 112 may be a portion of a top housing structure 138 or a sidewall housing structure 140 of FIG. 1, such as a glass structure (e.g., a curved glass structure). As examples, the access feature 114 may be a door or other feature for selectively allowing occupants to enter and/or exit the enclosed space 131 of FIG. 1.

As illustrated in FIG. 2, the electronic components 102 may include various components, such as a processor 190, wireless transceiver 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, one or more mapping sensors such as radar sensors, UWB sensors, LIDAR sensors, depth sensors, and/or time-of-flight sensors, temperature sensors, humidity sensors, etc. which may also be implemented in the other components 132 of FIG. 1), one or more microphones such as microphone 119, one or more speakers such as speaker 118, a display 110, and a touch-sensitive surface 122. These components optionally communicate over a communication bus 152. Although a single processor 190, wireless transceiver 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, wireless transceiver 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below.

In one or more implementations, UWB sensors 113 and/or other sensors (e.g., cameras 111) may be used to generate a spatial model or spatial map of the enclosed space 131, identify (e.g., detect) entry of an occupant into the enclosed space 131, identify (e.g., detect) exit of an occupant from the enclosed space 131, identify (e.g., detect) a portable electronic device and/or an occupant or object within the enclosed space 131, and/or to determine the location of a portable electronic device and/or an occupant or object within the enclosed space 131

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118 and/or with a separate display (e.g., a display of portable electronic device such as a smartphone, a tablet device, a laptop computer, a smart watch, or other device) within the enclosed space 131.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal-oxide-semiconductor (CMOS) sensors operable to obtain images within the enclosed space 131 and/or of an environment external to the enclosure 108. Camera 111 may also optionally include one or more infrared (IR) sensor(s), such as a passive IR sensor or an active IR sensor, for detecting infrared light from within the enclosed space 131 and/or of an environment external to the enclosure 108. For example, an active IR sensor includes an IR emitter, for emitting infrared light. Camera 111 also optionally includes one or more event camera(s) configured to capture movement of objects such as portable electronic devices and/or occupants within the enclosed space 131 and/or objects such as vehicles, roadside objects and/or pedestrians outside the enclosure 108. Camera 111 also optionally includes one or more depth sensor(s) configured to detect the distance of physical elements from the enclosure 108 and/or from other objects within the enclosed space 131. In some examples, camera 111 includes CCD sensors, event cameras, and depth sensors that are operable in combination to detect the physical setting around apparatus 100.

In some examples, UWB sensors 113 may operate as radar sensor(s) configured to emit radar signals, and to receive and detect reflections of the emitted radar signals from one or more objects in the environment around the enclosure 108. In some examples, UWB sensors 113 may operate as communication interfaces(s) configured to emit detection signals, and to receive and detect reply signals from one or more portable electronic devices in the environment around the enclosure 108 that respond to the detection signals. Other mapping sensors may also, or alternatively, include one or more scanners (e.g., a ticket scanner, a fingerprint scanner or a facial scanner), one or more depth sensors, one or more motion sensors, one or more temperature or heat sensors, or the like.

Other sensors may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) may include one or more gyroscopes, one or more magnetometers, and/or one or more accelerometers.

FIG. 3 illustrates a top view of an example implementation of the apparatus 100 in which various UWB sensors 113 are disposed at various locations to operate within the apparatus 100. In the example of FIG. 3, the apparatus 100 includes the enclosure 108 with one or more portable electronic devices 200 and/or objects 300 within the enclosure 108.

In various implementations, the UWB sensors 113 may be implemented as sensors that operate within an ultra-wideband range and/or another type of sensor, such as LIDAR sensors, depth sensors, time-of-flight sensors, image sensors (e.g., stereoscopic image sensors and/or image sensors provided with computer vision processing operations), or any other sensors that can be used to map a three-dimensional environment. For example, as shown in FIG. 3, sensors, such as UWB sensor 113 (e.g., alone or in combination with other mapping sensors, which may be included with or be implementations of the UWB sensor 113 of FIG. 2) may project sensing signals 192 (e.g., UWB signals) into the enclosed space 131.

The sensing signals 192 can be received by a portable electronic device 200 and recognized by the portable electronic device 200 as a polling request from the UWB sensor 113. In response, the portable electronic device 200 can generate a reply signal 194 for transmission to the UWB sensor 113. The UWB sensor 113 may receive the reply signal 194 from the portable electronic device 200. The charging system 150 can calculate a time-of-flight that includes a transmission time of the sensing signal 192, a processing time of the portable electronic device 200, and a transmission time of the reply signal 194. For example, the time-of-flight of the sensing signal 192 can be calculated as:

$${T}_{s e n s i n g} = \frac{{T}_{loop} - {T}_{reply}}{2}$$

where T_{sensing} is the transmission time of the sensing signal 192, Tₗₒₒₚ is the total time of flight (i.e., time from transmission of the sensing signal 192 from the UWB sensor 113 to receipt of the reply signal 194 at the UWB sensor 113), and T_{reply} is the combined processing time of the portable electronic device 200 and the transmission time of the reply signal 194. As such, T_{sensing} represents the time from transmission of the sensing signal 192 from the UWB sensor 113 to receipt of the sensing signal 192 at the portable electronic device 200. The processing time of the portable electronic device 200 can be known from calibrating steps and/or reported to the UWB sensor 113.

Based on the sensing signal 192 and the reply signal 194, the distance from the UWB sensor 113 to the portable electronic device 200 can be calculated (e.g., further based on a known speed of the sensing signal 192 and the reply signal 194). Such a determination can be performed individually with respect to a single UWB sensor 113. Additionally, such a determination can be performed individually for each of multiple UWB sensors 113 and/or transmitters of a single UWB sensor 113. Where distances from the portable electronic device 200 to multiple UWB sensors 113 is determined, the location of the portable electronic device 200 can be triangulated based on the known positions of the multiple UWB sensors 113.

In some implementations, the location of the portable electronic device 200 can be determined based on time difference of arrival. For example, the portable electronic device 200 can send a reply signal 194 to multiple UWB sensors 113. Each of the UWB sensors 113 can receive the reply signal 194 and record the time of receipt. The differences in time of receipt can be used to determine the location of the portable electronic device 200. It will be understood that the reply signal 194 can be transmitted from the portable electronic device 200 in response to a sensing signal 192 or without a preceding sensing signal 192.

The UWB sensor 113 may also receive reflected portions of the sensing signals 192. For example, objects 300 (e.g., occupants or other living beings, stationary items, moveable items, etc.) within the enclosure 108 can passively reflect the sensing signals 192 as return signals 196 without actively processing the sensing signals 192. The UWB sensor 113 may receive the return signal 196 reflected by an object 300. The charging system 150 can calculate a time-of-flight that includes a transmission time of the sensing signal 192 and a transmission time of the return signal 196. For example, the time-of-flight of the sensing signal 192 can be calculated as:

$${T}_{s e n s i n g} = \frac{{T}_{l o o p}}{2}$$

where T_{sensing} is the transmission time of the sensing signal 192 and Tₗₒₒₚ is the total time of flight (i.e., time from transmission of the sensing signal 192 from the UWB sensor 113 to receipt of the return signal 196 at the UWB sensor 113). As such, T_{sensing} represents the time from transmission of the sensing signal 192 from the UWB sensor 113 to incidence (e.g., reflection) at the object 300.

Based on the sensing signal 192 and the return signal 196, the distance from the UWB sensor 113 to the object 300 can be calculated (e.g., further based on a known speed of the sensing signal 192 and the return signal 196). Such a determination can be performed individually with respect to a single UWB sensor 113. Additionally, such a determination can be performed individually for each of multiple UWB sensors 113 and/or transmitters of a single UWB sensor 113. Where distances from the object 300 to multiple UWB sensors 113 is determined, the location of the object 300 can be triangulated based on the known positions of the multiple UWB sensors 113.

In some implementations, the location of the object 300 can be determined based on time difference of arrival. For example, the object 300 can reflect a sensing signal 192 as a return signal 196 to multiple UWB sensors 113. Each of the UWB sensors 113 can receive the return signal 196 and record the time of receipt. The differences in time of receipt can be used to determine the location of the object 300.

A spatial model can be generated based on the detections of return signals 196. The spatial model can include information indicating the locations and/or shapes of the walls of the enclosure 108, the locations and/or shapes of one or more objects 300, the locations and/or shapes of other structures (e.g., permanent apparatus structures and/or objects temporarily disposed within the enclosure) within the enclosure 108 that may obstruct charging beam paths, and/or the presence of one or more occupants within the enclosure 108. In the example of FIG. 3, the apparatus 100 includes six UWB sensors 113 from which sensing signals 192 can be transmitted and reply signals 194 and return signals 196 can be received. While the UWB sensor 113 is illustrated as a single unit, it will be understood that the UWB sensor 113 can have constituent parts distributed about the enclosure 108. Additionally or alternatively, multiple UWB sensors 113 can be provided. For example, the apparatus 100 may include one UWB sensor 113, two UWB sensors 113, three UWB sensors 113, four UWB sensors 113 (e.g., one at or near each corner of the enclosure 108), or another number of UWB sensors 113 at any suitable location(s) within the enclosure 108 for measuring the locations and/or shapes of objects 300 and/or portable electronic devices 200 within the enclosure 108.

The location of the portable electronic devices 200 within the enclosure 108 can be determined with respect to the spatial model. For example, the spatial model can be generated based on a known position and/or orientation of the charging system 150 (e.g., within a coordinate system). Furthermore, the location of the portable electronic devices 200 can be determined with respect to the charging system 150, for example with detections by the UWB sensor(s) 113. Accordingly, the location of the portable electronic devices 200 can be determined with respect to the spatial model, including any objects 300 within the enclosure 108.

Where the enclosure 108 can contain fixed structures (e.g., seats, instruments, integrated devices, supports, and the like), the charging system 150 can detect such structures as objects 300 and identify them as fixed structures within the enclosure based on their detection in an expected location. Where the enclosure 108 can temporarily contain movable items (e.g., portable electronic devices 200, occupants, pets, luggage, and the like), the charging system 150 can detect such structures as objects 300 and identify them as movable items based on their detection in locations other than those of the fixed structures. By further example, the charging system 150 can track movement of portable electronic devices 200 and/or objects 300 to identify them as moveable.

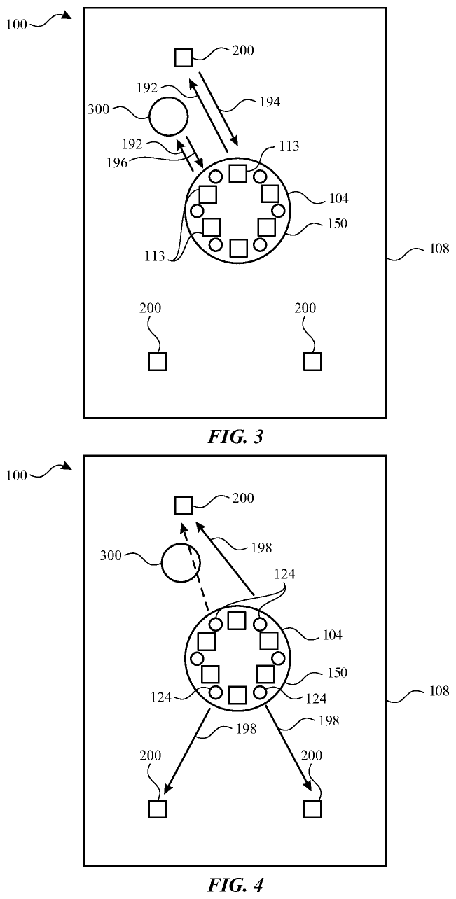

FIG. 4 illustrates another top view of an example implementation of the apparatus 100 in which various charging beam transmitters 124 are disposed at various locations for operation within the apparatus 100. In the example of FIG. 4, the charging beam transmitters 124 are operable to transmit wireless charging beams 198 to portable electronic devices 200 within the enclosure 108.

As shown in FIG. 4, charging beams 198 can be transmitted from corresponding charging beam transmitters 124 of the charging system 150 to one or more portable electronic devices 200. The charging beam transmitters 124 can be any device or component thereof for wirelessly charging the portable electronic device 200, as described further herein.

As further shown in FIG. 4, multiple charging beam transmitters 124 can be included. As such, any one or more of the multiple charging beam transmitters 124 can be selected for transmitting the corresponding charging beam 198. Such a determination can be made, at least in part, based on a desired charging beam path.

In the example of FIG. 4, the apparatus 100 includes six multiple charging beam transmitters 124 from which charging beams 198 can be transmitted. It will be understood that the charging system 150 can have any number of charging beam transmitters 124 distributed about the enclosure 108. For example, the apparatus 100 may include one charging beam transmitter 124, two charging beam transmitters 124, three charging beam transmitters 124, four charging beam transmitters 124 (e.g., one at or near each corner of the enclosure 108), or another number of charging beam transmitters 124 at any suitable location(s) within the enclosure 108 for transmitting charging beams 198 to portable electronic devices 200 within the enclosure 108.

For example, where locations of a portable electronic device 200 and one or more objects 300 is determined within a spatial model, prospective charging beam paths can be considered from each of multiple charging beam transmitters 124. Where any such path is determined to pass through an object 300, the corresponding charging beam transmitters 124 can be determined to be less preferred than one that provides a path that does not pass through the object 300 or any other obstruction.

In some implementations, a number of factors can be considered in the selection of one of the charging beam transmitters 124. For example, one of the charging beam transmitters 124 can be selected as one that provides a path without any obstruction. By further example, one of the charging beam transmitters 124 can be selected as one that provides a path through a relatively small number of obstructions. By further example, one of the charging beam transmitters 124 can be selected as one that provides a path through an object 300 that is known to transmit charging beams, such as a known fixed structure of the apparatus 100 that transmits charging beams without significant reflection, interference, or losses. By further example, one of the charging beam transmitters 124 can be selected as one that does not provide a path through an occupant or other moveable object. By further example, one of the charging beam transmitters 124 can be selected as one that provides a relatively short path to the portable electronic device 200.

In some implementations, where an object 300 obstructs a path to a portable electronic device 200, a different charging beam transmitter 124 can be selected. In some implementations, where all paths provided by charging beam transmitters 124 are obstructed, no charging beam can be provided. In some implementations, where all paths provided by charging beam transmitters 124 are obstructed, a notification can be output by the apparatus 100 to move the portable electronic device 200.

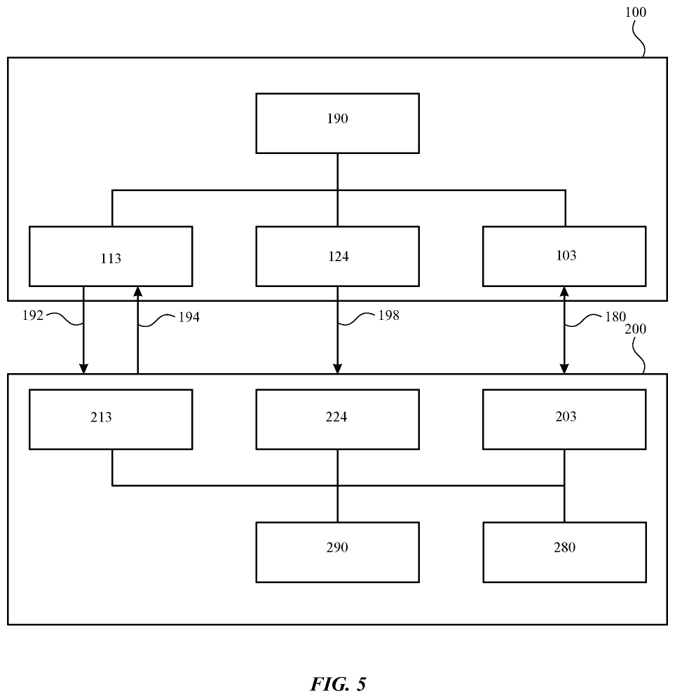

In various implementations, the charging system 150 and the portable electronic device 200 may include one or more other electronic and/or computing components and/or circuitry that are not shown in FIGS. 1-4. For example, FIG. 5 illustrates a schematic diagram of a charging system 150 of an apparatus and a portable electronic device 200 in accordance with one or more implementations.

As shown in FIG. 5, the charging system 150 can include a processor 190 operatively coupled to other components of the charging system 150, as described herein.

The charging system 150 can further include one or more UWB sensors 113, and the portable electronic device 200 and include one or more UWB interfaces 213. The UWB sensors 113 may be implemented as sensors that operate, for example, within an ultra-wideband range. The UWB sensor 113 of the charging system 150 may transmit sensing signals 192 to the UWB interfaces 213 of the portable electronic device 200. The UWB interfaces 213 of the portable electronic device 200 can transmit a reply signal 194 to the UWB sensor 113. Accordingly, each of the UWB sensor 113 and the UWB interface 230 can include components to facilitate both transmission and reception of signals. The transmitting components can include, for example, an impulse generator, a pulse modulator, an amplifier, and/or an antenna. The receiving components can include, for example, an antenna, a band pass filter, a low-noise amplifier, a correlator, and/or an analog-digital converter.

The charging system 150 can further include one or more charging beam transmitters 124, and the portable electronic device 200 and include one or more charging beam receivers 224. The charging beam transmitters 124 can be any device or component thereof for wirelessly charging the portable electronic device 200 with charging beam 198. For example, the charging beam transmitters 124 can include RF transmitters. In some implementations, the charging beam transmitters 124 of the charging system 150 can generate radio waves by applying alternating currents (AC) to an antenna to produce time-varying electromagnetic fields that radiate outward from the antenna to distribute energy. Directional antennas can be used to concentrate energy within a specific range for increasing charging distance and charging efficiency. Additionally or alternatively, omnidirectional antennas can be used. The charging beam transmitters 124, individually or in combination, can form an antenna array for beamforming, for example being connected together and arranged into different geometrical configurations, such as linear, planar and circular structures. The RF waves radiated by each antenna element can be constructively and destructively combined together so that the power radiated in the target direction is enhanced, and the power radiated in other directions is reduced. Such beamforming can be achieved by varying the phase and the amplitude of signals fed to each antenna element of the array.

The UWB sensor 113 of the charging system 150 can be configured to transmit the sensing signal 192 with a frequency that is different than a frequency of the charging beam 198. Additionally or alternatively, the UWB interface 213 of the portable electronic device 200 can be configured to transmit the reply signal 194 with a frequency that is different than a frequency of the charging beam 198. In some implementations, the charging beam 198 can have a lower frequency than the sensing signal 192 and/or the reply signal 194. For example, the sensing signal 192 and/or the reply signal 194 can be within an ultra-wideband frequency (e.g., 3.1-10.6 GHz). By further example, the charging beam 198 can be within an RF frequency (e.g., 80-300 kHz).

The portable electronic device 200 can further include a battery 280 for storing power received by the charging beam receivers 224. The battery 280 can further provide power to one or more components of the portable electronic device 200.

The charging system 150 can further include one or more wireless transceivers 103, and the portable electronic device 200 and include one or more wireless transceivers 203. Communications circuitry, such as wireless transceiver 103 and/or wireless transceiver 203, optionally includes circuitry for communicating across communication link 180 between electronic devices, networks, such as the Internet, intranet(s), and/or a wireless network, such as cellular networks, wireless local area networks (LANs), and/or direct peer-to-peer wireless connections. The wireless transceiver 103 and/or the wireless transceiver 203 optionally includes circuitry for communicating using near-field communication and/or short-range communication, such as Bluetooth®. The wireless transceiver 103 of the charging system 150 may be operated (e.g., by processor 190) to communicate with the wireless transceiver 203 of portable electronic device 200. For example, the wireless transceiver 103 may be operated to communicate with a portable electronic device 200 to determine the presence of the portable electronic device in the enclosed space, to identify the portable electronic device 200, to pair with the portable electronic device 200, to transmit information (e.g., charging activity of charging beam transmitters 124) to the portable electronic device 200, and/or to receive information (e.g., charge status of battery 280) from the portable electronic device 200.

In the example of FIG. 5, the portable electronic device 200 further includes a processor 290. The processor 290 may include one or more general processors, one or more graphics processors, and/or one or more digital signal processors. In some examples, a memory can further be provided with one or more non-transitory computer-readable storage mediums (e.g., flash memory, random access memory, volatile memory, non-volatile memory, etc.) that store computer-readable instructions configured to be executed by the processor 290 to perform the techniques described below.

The portable electronic device 200 can include a number of other features not depicted in the drawings. For example, the portable electronic device 200 can include a display mounted on a housing, one or more input/output devices such as a touch screen incorporated into the display, a button or switch, and/or other input output components disposed on or behind the display. By further example, the portable electronic device 200 can include a device speaker, a microphone, a light source, and/or a camera.

The portable electronic device 200 can be implemented using a housing that is sufficiently small to be portable and carried by a user. For example, the portable electronic device 200 may be a handheld electronic device such as a tablet computer or a cellular telephone or smart phone), a somewhat larger electronic device such as a laptop computer, or a wearable electronic device such as a smart watch.

In some implementations, the portable electronic device 200 may be a laptop computer, a wearable device such as a smart watch, a pendant device, or other wearable or miniature device, a media player, a gaming device, a navigation device, or any other portable electronic device having a speaker and display. In some implementations, portable electronic device 200 may be provided in the form of a wearable device such as a smart watch. In some implementations, a housing of the portable electronic device 200 may include one or more interfaces for mechanically coupling the housing to a strap or other structure for securing the housing to a wearer.

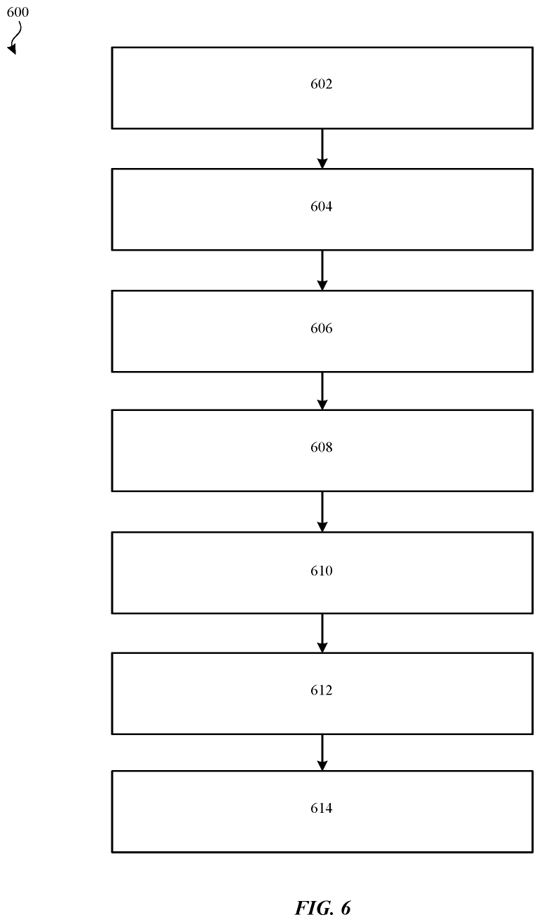

FIG. 6 illustrates a flow diagram of an example process 600 for providing spatial modeling of enclosed environments for charging a portable electronic device, in accordance with implementations of the subject technology. For explanatory purposes, the process 600 is primarily described herein with reference to the apparatus 100 (e.g., charging system 150) and the portable electronic device 200 of FIGS. 1-5. However, the process 600 is not limited to the apparatus 100 and the portable electronic device 200 of FIGS. 1-5, and one or more blocks (or operations) of the process 600 may be performed by one or more other components of other suitable devices or systems. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

At block 602, the apparatus may identify a portable electronic device within the enclosed space. Identifying the portable electronic device may include detecting the portable electronic device using, for example, a wireless transceiver in communication with a wireless transceiver of the portable electronic device. By further example, identifying the portable electronic device may be based on operation of the UWB sensor. The identification of a portable electronic device and/or a charging status (e.g., battery charge level) thereof can result in further operations. For example, identifying the portable electronic device upon introduction thereof into the enclosed space can prompt the charging system to determine charging needs of the portable electronic device and/or other conditions.

At block 604, the charging system can operate one or more UWB sensors to detect the location of the portable electronic device and/or objects within an enclosed space. In particular, a UWB sensor can be operated to transmit a sensing signal to portable electronic devices and/or objects within the enclosed space. It will be understood that the sensing signal can be narrowly targeted or more broadly projected. A single sensing signal can be broadcast to both portable electronic devices and toward objects. Additionally or alternatively, separate sensing signals can be transmitted to portable electronic devices and/or objects simultaneously or sequentially.

At block 606, the UWB sensor can receive a reply signal from a portable electronic device. In some implementations, the reply signal can have been generated by the portable electronic device in response to the sensing signal. In some implementations, the reply signal can have been generated by the portable electronic device based on a schedule, a condition of the portable electronic device, and/or other criteria.

At block 608, the UWB sensor can receive a return signal from one or more objects. The return signal can be a reflection of the sensing signal transmitted by the UWB sensor,

At block 610, the charging system generates, using the detections of the UWB sensor, a spatial model of an enclosed space within an enclosure of the apparatus (e.g., moveable platform or vehicle). The spatial model may include, for example, a three-dimensional model or map indicating the locations and/or shapes of the boundaries (e.g., walls, windows, ceiling, floor of the enclosure) of the enclosed space and/or the locations and/or shapes of objects within the enclosure (e.g., seats, luggage carried into the enclosure by an occupant, occupants themselves, or the like). The spatial model may be stored in as a parameterized mathematical model, in image space, vector space, tensor space, or any other suitable format for storing a spatial model. In one or more implementations, mapping sensors can include the UWB sensor. In one or more implementations, the mapping sensor may include a LIDAR sensor, a time-of-flight sensor, a depth sensor, one or more cameras, and/or other sensors. In one or more implementations, the spatial model may be generated based on mapping data from multiple UWB sensors operating concurrently within the enclosure.

At block 612, the charging system may determine, using the detections of the UWB sensor, a location of the portable electronic device. For example, determining the location of the portable electronic device may include emitting the sensing signal (block 604) into the enclosed space and determining the location of the portable electronic device based on the known emitted sensing signal and one or more reply signals (block 606).

At block 614, the charging system transmits a charging beam from one or more charging beam transmitters to the portable electronic device. As described herein, the charging beams can be transmitted along paths that are determined to not be obstructed by one or more objects within the enclosed space. Such a determination can be based upon a determined location of the portable electronic device within the spatial model as well as objects within the enclosed space and/or that contribute to the boundaries of the spatial model. In some implementations, transmitting the charging beam can include determining which of multiple charging beam transmitters can provide a preferred (e.g., unobstructed) path therefrom to the portable electronic device.

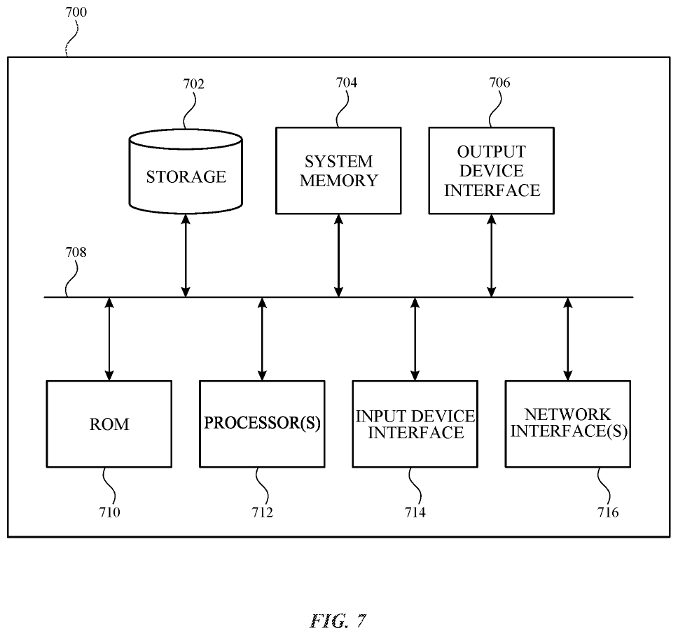

FIG. 7 illustrates an electronic system 700 with which one or more implementations of the subject technology may be implemented. The electronic system 700 can be, and/or can be a part of, the portable electronic device 200 shown in FIG. 7. The electronic system 700 can be, and/or can be a part of, the apparatus 100 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

Various processes defined herein consider the option of obtaining and utilizing a user's personal information. For example, such personal information may be utilized for spatial modeling of enclosed environments for control of acoustic components. However, to the extent such personal information is collected, such information should be obtained with the user's informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

Various examples of aspects of the disclosure are described below as clauses for convenience. These are provided as examples, and do not limit the subject technology.

Clause A: a charging system for an enclosed space, the charging system comprising: an ultra-wideband (UWB) sensor within the enclosed space and configured to detect a location of a portable electronic device within the enclosed space and a location of an object within the enclosed space; multiple charging beam transmitters within the enclosed space; and a processor configured to: determine a path from one of the charging beam transmitters to the portable electronic device that is not obstructed by the object; and operate the one of the charging beam transmitters to transmit a charging beam along the path to the portable electronic device.

Clause B: a charging system for an enclosed space, the charging system comprising: an ultra-wideband (UWB) sensor; multiple charging beam transmitters; and a processor configured to: determine, based on operation of the UWB sensor, a path from one of the charging beam transmitters to a portable electronic device that is not obstructed by an object; and operate the one of the charging beam transmitters to transmit a charging beam along the path to the portable electronic device.

Clause C: a charging system for an enclosed space, the charging system comprising: an ultra-wideband (UWB) sensor configured to transmit a sensing signal to a portable electronic device and an object within the enclosed space, receive a reply signal from the portable electronic device, and receive a return signal from the object; a processor configured to generate, using the return signal, a spatial model of the enclosed space and determine, using the reply signal, a location of the portable electronic device within the spatial model; and a charging beam transmitter configured to, based on the spatial model and the location of the portable electronic device, transmit a charging beam to the portable electronic device.

One or more of the above clauses can include one or more of the features described below. It is noted that any of the following clauses may be combined in any combination with each other, and placed into a respective independent clause, e.g., clause A, B, or C.

Clause 1: a wireless transceiver configured to communicate with the portable electronic device.

Clause 2: the location of the portable electronic device within the enclosed space is determined based on a time of flight of a sensing signal transmitted from the UWB sensor and received by the portable electronic device, a processing time of the portable electronic device, and a time of flight of a reply signal transmitted from the portable electronic device and received by the UWB sensor.

Clause 3: the location of the object within the enclosed space is determined based on a time of flight of a sensing signal from the UWB sensor to the object and a return signal, comprising a reflection of the sensing signal, back from the object to the UWB sensor.

Clause 4: the processor is further configured to generate, using the UWB sensor, a spatial model of the enclosed space.

Clause 5: the processor is configured to determine the path by: generating, using the UWB sensor, a spatial model of the enclosed space, the spatial model including the location of the object and locations of the charging beam transmitters; and determining, using the UWB sensor, the location of the portable electronic device within the spatial model.

Clause 6: the UWB sensor is configured to transmit a sensing signal with a frequency that is different than a frequency of the charging beam.

Clause 7: the processor is further configured to: operate the UWB sensor to detect a location of an additional portable electronic device within the enclosed space; determine an additional path from an additional one of the charging beam transmitters to the additional portable electronic device that is not obstructed by the object; and operate the additional one of the charging beam transmitters to transmit an additional charging beam along the additional path to the additional portable electronic device.

Clause 8: a wireless transceiver configured to identify the portable electronic device, wherein the processor is configured to operate the UWB sensor in response to an identification of the portable electronic device.

Clause 9: the processor is further configured to: determine a location of the portable electronic device based on a time of flight of a sensing signal transmitted from the UWB sensor and received by the portable electronic device, a processing time of the portable electronic device, and a time of flight of a reply signal transmitted from the portable electronic device and received by the UWB sensor; and determine a location of the portable electronic device based on a time of flight of the sensing signal from the UWB sensor to the object and a return signal, comprising a reflection of the sensing signal, back from the object to the UWB sensor.

Clause 10: the processor is further configured to: generate, using the UWB sensor, a spatial model including a location of the object and locations of the charging beam transmitters; and determine, using the UWB sensor, a location of the portable electronic device within the spatial model.

Clause 11: the UWB sensor is configured to transmit the sensing signal with a frequency that is different than a frequency of the charging beam.

Clause 12: the processor is further configured to: determine an additional path from an additional one of the charging beam transmitters to an additional portable electronic device that is not obstructed by the object; and operate the additional one of the charging beam transmitters to transmit an additional charging beam along the additional path to the additional portable electronic device.

Clause 13: the spatial model is generated based on a time of flight of the sensing signal and the return signal, comprising a reflection of the sensing signal, and the location of the portable electronic device within the spatial model is determined based on a time of flight of the sensing signal, a processing time of the portable electronic device, and a time of flight of the reply signal.

Clause 14: the spatial model includes the location of the object and locations of the charging beam transmitter.

Clause 15: the UWB sensor is further configured to receive an additional reply signal from an additional portable electronic device; the processor is further configured to determine, using the additional reply signal, a location of the additional portable electronic device within the spatial model; and an additional charging beam transmitter is configured to, based on the spatial model and the location of the additional portable electronic device, transmit an additional charging beam to the additional portable electronic device.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAIVI, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. A charging system for an enclosed space, the charging system comprising:
an ultra-wideband (UWB) sensor within the enclosed space and configured to detect a location of a portable electronic device within the enclosed space and a location of an object within the enclosed space;
multiple charging beam transmitters within the enclosed space; and
a processor configured to:
determine a path from one of the charging beam transmitters to the portable electronic device that is not obstructed by the object; and
operate the one of the charging beam transmitters to transmit a charging beam along the path to the portable electronic device.

2. The charging system of claim 1, further comprising a wireless transceiver configured to communicate with the portable electronic device.

3. The charging system of claim 1, wherein the location of the portable electronic device within the enclosed space is determined based on a time of flight of a sensing signal transmitted from the UWB sensor and received by the portable electronic device, a processing time of the portable electronic device, and a time of flight of a reply signal transmitted from the portable electronic device and received by the UWB sensor.

4. The charging system of claim 1, wherein the location of the object within the enclosed space is determined based on a time of flight of a sensing signal from the UWB sensor to the object and a return signal, comprising a reflection of the sensing signal, back from the object to the UWB sensor.

5. The charging system of claim 1, wherein the processor is further configured to generate, using the UWB sensor, a spatial model of the enclosed space.

6. The charging system of claim 1, wherein the processor is configured to determine the path by:
generating, using the UWB sensor, a spatial model of the enclosed space, the spatial model including the location of the object and locations of the charging beam transmitters; and
determining, using the UWB sensor, the location of the portable electronic device within the spatial model.

7. The charging system of claim 1, wherein the UWB sensor is configured to transmit a sensing signal with a frequency that is different than a frequency of the charging beam.

8. The charging system of claim 1, wherein the processor is further configured to:
operate the UWB sensor to detect a location of an additional portable electronic device within the enclosed space;
determine an additional path from an additional one of the charging beam transmitters to the additional portable electronic device that is not obstructed by the object; and
operate the additional one of the charging beam transmitters to transmit an additional charging beam along the additional path to the additional portable electronic device.

9. A charging system for an enclosed space, the charging system comprising:
an ultra-wideband (UWB) sensor;
multiple charging beam transmitters; and
a processor configured to:
determine, based on operation of the UWB sensor, a path from one of the charging beam transmitters to a portable electronic device that is not obstructed by an object; and
operate the one of the charging beam transmitters to transmit a charging beam along the path to the portable electronic device.

10. The charging system of claim 9, further comprising a wireless transceiver configured to identify the portable electronic device, wherein the processor is configured to operate the UWB sensor in response to an identification of the portable electronic device.

11. The charging system of claim 9, wherein the processor is further configured to:
determine a location of the portable electronic device based on a time of flight of a sensing signal transmitted from the UWB sensor and received by the portable electronic device, a processing time of the portable electronic device, and a time of flight of a reply signal transmitted from the portable electronic device and received by the UWB sensor; and
determine a location of the portable electronic device based on a time of flight of the sensing signal from the UWB sensor to the object and a return signal, comprising a reflection of the sensing signal, back from the object to the UWB sensor.

12. The charging system of claim 9, wherein the processor is further configured to:
generate, using the UWB sensor, a spatial model including a location of the object and locations of the charging beam transmitters; and
determine, using the UWB sensor, a location of the portable electronic device within the spatial model.

13. The charging system of claim 9, wherein the UWB sensor is configured to transmit the sensing signal with a frequency that is different than a frequency of the charging beam.

14. The charging system of claim 9, wherein the processor is further configured to:
determine an additional path from an additional one of the charging beam transmitters to an additional portable electronic device that is not obstructed by the object; and
operate the additional one of the charging beam transmitters to transmit an additional charging beam along the additional path to the additional portable electronic device.

15. A charging system for an enclosed space, the charging system comprising:
an ultra-wideband (UWB) sensor configured to transmit a sensing signal to a portable electronic device and an object within the enclosed space, receive a reply signal from the portable electronic device, and receive a return signal from the object;
a processor configured to generate, using the return signal, a spatial model of the enclosed space and determine, using the reply signal, a location of the portable electronic device within the spatial model; and
a charging beam transmitter configured to, based on the spatial model and the location of the portable electronic device, transmit a charging beam to the portable electronic device.

16. The charging system of claim 15, further comprising a wireless transceiver configured to identify the portable electronic device, wherein the processor is configured to operate the UWB sensor in response to an identification of the portable electronic device.

17. The charging system of claim 15, wherein:
the spatial model is generated based on a time of flight of the sensing signal and the return signal, comprising a reflection of the sensing signal, and
the location of the portable electronic device within the spatial model is determined based on a time of flight of the sensing signal, a processing time of the portable electronic device, and a time of flight of the reply signal.

18. The charging system of claim 15, wherein the spatial model includes the location of the object and locations of the charging beam transmitter.

19. The charging system of claim 15, wherein the UWB sensor is configured to transmit the sensing signal with a frequency that is different than a frequency of the charging beam.

20. The charging system of claim 15, wherein:
the UWB sensor is further configured to receive an additional reply signal from an additional portable electronic device;
the processor is further configured to determine, using the additional reply signal, a location of the additional portable electronic device within the spatial model; and
an additional charging beam transmitter is configured to, based on the spatial model and the location of the additional portable electronic device, transmit an additional charging beam to the additional portable electronic device.
